(19) United States
(12) Patent Application Publication
(10) Pub. No.: US 2005/0243210 A1
(43) Pub. Date: Nov. 3, 2005

(54) DISPLAY SYSTEM FOR DISPLAYING SUBTITLES

(76) Inventor: Wen-Chin Lee, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/709,984

(22) Filed: Jun. 10, 2004

(30) Foreign Application Priority Data
Apr. 16, 2004 (TW) 093110684

(51) Int. Cl. H04N 5/445

(52) U.S. Cl. 348/564; 348/569

(57) ABSTRACT

A display system embedded in a media player has an on-screen display (OSD) function for displaying an operation status of the player. When the player obtains a medium signal and outputs a video signal within the medium signal to a screen for displaying video, the invention utilizes software-parsing to parse a subtitle signal within the medium signal, and obtains a text signal within the subtitle signal. Then the subtitle text can be displayed as OSD text using the OSD function of the player.

### BACKGROUND OF INVENTION

1. Field of the Invention

The present invention relates to a display system embedded into a media player, and more particularly, to a display system for displaying subtitles utilizing the on-screen display (OSD) function of the player.

2. Description of the Prior Art

In the modern information society, dynamic images (motion pictures) and voice are recorded into multimedia video data. Information, knowledge, news, and entertainment are displayed by video and sound. Multimedia video data can be stored in optical, magnetic, or electrical storage media, such as compact disc (CD), digital versatile disc (DVD), hard disc, RAM, flash memory, and etc. When displaying multimedia video data, a media player is used for accessing the video data stored in the storage media, transforming the video data into electric signals, and transmitting the electric signals to a display (and a speaker) to display the images (and sound) of the video data for viewers to experience.

In some situations, the multimedia video data is required to display a “caption” which combines text data and dynamic images into one graphic frame. For instance, those who have hearing difficulties might not acquire all information of the video data. For this demand, “subtitles” or “closed captioning” are typically used. In subtitles, voice data of the video is described by text data, which is in the form of a static caption within the dynamic images displayed for viewers. However, such subtitles (closed caption) are not required by all viewers. Thus, they can be switched off and only displayed only when needed by the viewer.

Please refer to FIG. 1. FIG. 1 is a diagram of a subtitle Ct and a dynamic image Im. As mentioned above, the subtitle Ct can utilize text to describe voice information of characters and background. This can assist viewers needing help to understand the multimedia video data. As shown in FIG. 1, generally, when displaying subtitles, the text of the subtitle is displayed in a square of dark color (such as black).

In the prior art, the displaying of subtitles requires a media player and a display, which have specialized equipment. Please refer to FIG. 2. FIG. 2 is a diagram of a subtitle display system 10 embedded between a player 12 and a display 14 according to the prior art. The player 12 is an optical player (such as a DVD player) having a driving system 16, an access module 18 and a coding module 20. The display 14 is a TV having a screen 24. Additionally, in order to support the prior art subtitle display system 10, the display 14 further has a decoding module 22. The prior art subtitle display system 10 is achieved by the combination of the coding module 20 of the player 12 and the decoding module 22 of the display 14.

The driving system 16 of the player 12 accesses video data from storage media (such as a CD or DVD). The video data is transformed into electric medium signal 26 by the access module 18. The electric medium signal 26 includes a video signal 25A and a subtitle signal 25B, wherein the video signal 25A stores dynamic images of the video data and the subtitle signal 25B stores text data and the format (such as font size) of the subtitle. The video signal 25A and the subtitle signal 25B of the medium signal 26 are encoded by the coding module 20 and transformed into a display signal 28 transmitted to the display 14.

As known in the art, the screen of the display updates scan lines one by one to form the full frame for displaying dynamic images. Therefore, the video display signal acceptably received by the display represents the frame information of dynamic images in the form of scan lines. For example, in NTSC (National Television System Committee) format, each frame includes 525 scan lines with each scan line corresponding to a scan line data, which records the data represented by the scan line. Due to the time of scanning the frame in the vertical direction, several tens of lines of the 525 scan lines actually are not displayed on the screen. These scan lines are called invisible scan lines. The scan lines actually displayed on the screen are called visible scan lines. The visible scan line data corresponding to a visible scan line records the frame displayed by the scan line. The invisible scanning data corresponding to an invisible scan line can carry additional information. In the prior art, subtitle display system 10, the invisible scan line data (such as the twenty-first scan line in NTSC) is utilized for recording subtitle information.

In FIG. 2, the display signal 28 includes a plurality of visible scan line data 27B and invisible scan line data 27A. In the prior art, the subtitle information is coded within the invisible scan line data 27A. For representing subtitles, the prior art display 14 must have a corresponding decoding module 22. The decoding module 22 decodes the text data related to subtitles from the invisible scan line data so that the text of the subtitles can be displayed with dynamic images of the visible scan line data 27B on the screen 24. Of course, if viewers need not display the subtitle, viewers can control the display 14 to stop the operation of the decoding module 22. And since the information related to subtitles is coded within the invisible scan line data, naturally the subtitles are not displayed on the screen.

As known from the above, the prior art subtitle display system 10 codes the information related to the subtitles within the invisible scan line data. Therefore, the decoding module 22 of the display 14 is required to actually display the subtitles. In other words, when viewers utilize the special function of subtitles (like closed caption), the display embedding the decoding module for subtitles is required to get the subtitle information. In this case, the cost of the prior art subtitle display system is increased and it is inconvenient for viewers to use the function of subtitles. In addition, the prior art subtitle display system cannot allow viewers to choose the form of the subtitles, such as the font size, the position of subtitle text in the frame, the font color, etc. As mentioned above, in the medium signal 25 provided by the access module 18, the subtitle signal 25B indicates the display form of the subtitle and the coding module 20 codes the information related to the subtitle into the visible scan line data based on the indicated display form. Therefore, the actual display form is decided by the subtitle signal 25B, not by viewers. Furthermore, viewers control the display of multimedia from the player and have to operate the display to control whether the subtitle is desired to be displayed or not. This also makes it inconvenient for viewers to use the prior art system.

### SUMMARY OF INVENTION

It is therefore a primary objective of the claimed invention to provide a subtitle display system not requiring the decoding module of the display to solve the above-mentioned problems.

Generally, media players have an on-screen display (OSD) function to graphically display the status of the player on the display. That is, a visible user interface of the media players is provided on the display. The present invention utilizes the OSD function of the player to display subtitles (like closed caption). After the player receives the medium signal from the storage media, the present invention utilizes software parsing to parse the subtitle signal within the medium signal so that the text data of the subtitle is extracted from the subtitle signal and mapped to OSD text. Then the OSD function of the player is used for displaying the OSD text of the subtitle on the display. In other words, the present invention takes the text of the subtitle as one kind of OSD statuses of the player. Then the text of the subtitle is represented on the display by the OSD function of the player.

The present invention utilizes the OSD function of the media player to display subtitles. A subtitle is regarded as a part of the visible frame, directly mixed into the visible scan line data by the player and transmitted to the display. In this case, even though the display does not have a decoding module for subtitles, the display can still represent subtitles on the screen for viewers. When the present invention is implemented, due to the present invention utilizing software parsing to directly parse the text data of the subtitle from the subtitle signal and displaying the text of the subtitle with typefaces provided by the OSD function, the present invention can provide viewers with additional display options (such as the font size, color, typeface, and the position in the frame, etc.). The present invention displays subtitles by the OSD function of the media player, and therefore, viewers only have to operate the player to control whether the subtitles are displayed or not.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a subtitle and a dynamic image.

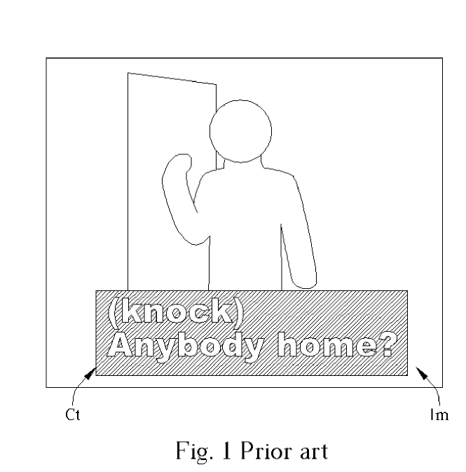

FIG. 2 is a diagram of a subtitle display system according to the prior art.

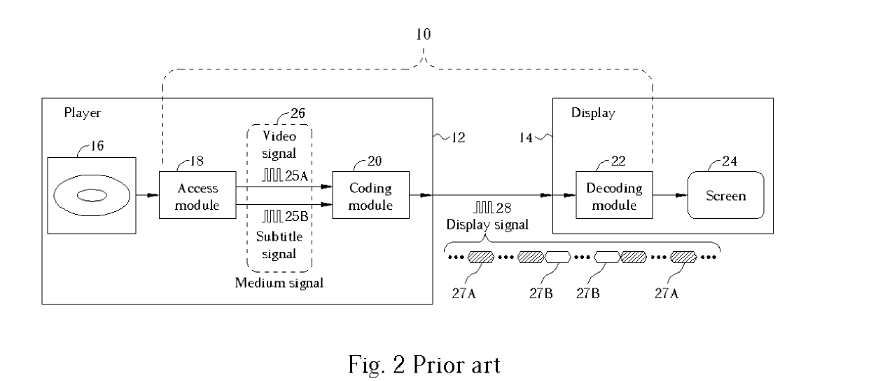

FIG. 3 is a diagram of a subtitle display system according to the present invention.

### DETAILED DESCRIPTION

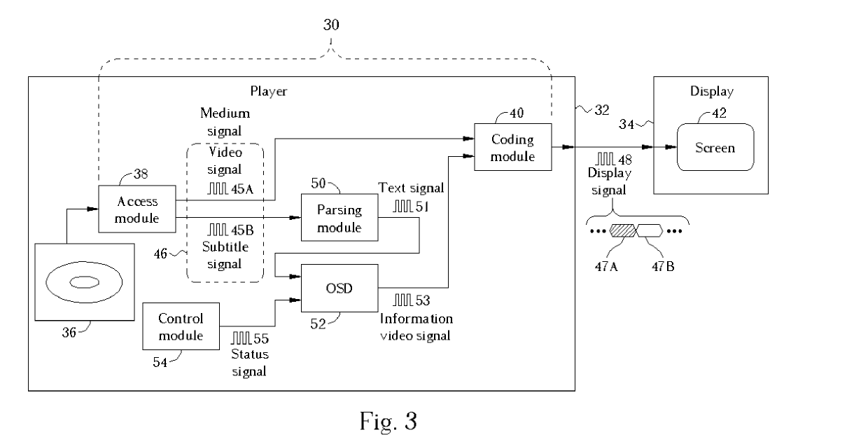

Please refer to FIG. 3. FIG. 3 is a diagram of a subtitle display system 30 embedded in a media player 32 according to the present invention. The player 32 is an optical player (such as a DVD player) or other storage media player to access the video data from the storage media and display the video on a display 34 for viewers. The player 32 includes a driving system 36, an access module 38, a control module 54, an on-screen display (OSD) module 52 and a coding module 40. In order to implement the present invention, the player 32 further includes a parsing module 50. The driving system 36 reads the video data from the storage media (such as an optical storage media). The access module 38 generates a corresponding electric medium signal 46 based on the video data. The medium signal includes a video signal 45A and a subtitle signal 45B, wherein the video signal 45A represents dynamic images and voice of the video data and the subtitle signal 45B represents information related to the subtitles. The control module 54 is utilized for controlling the operation of the player 30.

As mentioned above, modern players have the OSD function to display the status of the player on the screen of the display. In the player 32, the OSD module 52 is used for achieving the OSD function. The control module 54 generates a corresponding status signal 55 based on the status of the player 32, the status signal 55 being the input signal of the OSD module 52. The OSD module 52 generates a corresponding information video signal 53 according to the received signals. The coding module 40 mixes and encodes the information video signal 53 of the OSD module 52 and the video signal 45A of the medium signal 46 into a display signal 48 acceptably received by the display 34, and transmits the display signal 48 to the display 34, wherein the video signal 45A representing the dynamic image frame and the information video signal 53 representing the information frame of the status of the player 32. After the coding module 40 encodes both signals into the display signal 48, the screen 42 of the display 34 represents the frame that the information frame overlaps the dynamic image frame. Therefore, viewers can get the status of the player 32 on the screen 42. For instance, the information video signal 53 of the OSD module 52 is text or figures to indicate that the player 32 plays normally, rewinds and plays the video data at high or low speed, or the time and chapter of the video the player 32 playing.

Due to the display of the information video signal 53 of the OSD module 52 being displayed for viewers, the coding module 40 directly mixes the information video signal 53 into the visible scan line data 47B of the display signal 48 instead of the invisible scan line data 47A. Therefore, when the visible scan line data 47B is displayed on the screen 42, the corresponding information (the status of the player 32) of the information video signal 53 is also displayed for achieving the OSD function of the player 32.

The subtitle display system 30 of the present invention can be achieved by the player 32 with the OSD function. As mentioned above, in the medium signal 46 provided by the access module 38, the subtitle signal 46 records the information related to subtitles. For example, there is user data in DVD for recording the subtitle signal of the closed caption, the subtitle signal having a caption signal and a control signal, wherein the caption signal stores the text of the subtitle (such as text in ASCII code) and the control signal stores the typeface, size, color, position of the text and the color of the background square (opaque or transparent). When the subtitle display system 30 of the present invention is implemented, the parsing module 50 utilizes software parsing to parse the caption signals from the subtitle signal 45B and map the caption signals to the text signal 51. Next, the text signal 51 is regarded as the input signal of the OSD module 52. The OSD module 52 takes the text signal 51 as the OSD status to be displayed on the screen 42 and combines the text signal 51 into the information video signal 53. Therefore, when the coding module 40 encodes the video signal 45A and the information video signal 53 into the display signal 48, the text of the subtitle is considered as the content of the information, encoded within the visible scan line data 47B and displayed on the screen 42 of the display 34.

In other words, when displaying subtitles, the present invention utilizes the parsing module 50 to parse the actual text of the subtitle signal and considers the text as the content of the information displayed on the screen 42 for viewers. On the contrary, if viewers desire not to use the subtitle function, they need only to operate the player 32 to stop the parsing module 50 transforming the subtitle signal 45B into the text signal 51 such that subtitles are not displayed.

Compared to the prior art, the present invention system for rendering subtitles has the following advantages. First, the present invention does not require a decoding module of the display. That is, even though the display has no decoding module, the present invention also can display subtitles, like closed caption. Therefore, the present invention can reduce the cost of the subtitle system and simplify an implementation.

In addition, the present invention allows viewers to choose the form of the display of subtitles. In the prior art subtitle display system, the form of the subtitle is directly controlled by the control signal of the subtitle signal. The coding module directly encodes the subtitle signal into the invisible scan line data based on the control signal; therefore, viewers cannot choose the form of the subtitles. However, the present invention utilizes the OSD function of the player to display subtitles; therefore, viewers can choose the subtitle form via the OSD function. For instance, when the present invention is implemented, the OSD module 52 can contains several different font sizes of the text. When viewers choose the small typeface for displaying the text of the subtitle, the display is in the form of the small typeface. Furthermore, despite the playing of the multimedia and whether the subtitles are displayed or not, viewers only have to operate the player to simplify the operation. That is, when operating the OSD module 52 of the present invention, the control signal appears to be filtered out from the subtitle signal so that the text signal within the subtitle signal is parsed and viewers can choose the form of the display of the subtitles. Of course, when the present invention is implemented, a default forms of the subtitles can be established in the OSD module 52. The default form of the subtitle could be set similar to the common display existing in the current subtitle, so the subtitle can be displayed in forms familiar to viewers. In other embodiments of the present invention, the OSD module 52 also receives the control signal of the subtitle signal 45B so that the subtitles are displayed according to the control signal.

Compared to the prior art, the OSD subtitle display system of the present invention can reduce the cost and simplify the operation of displaying subtitles. In the present invention, the parsing module 50 can be implemented by software or hardware. The player 32 could be a common media player or a multimedia computer.

Those skilled in the art will readily observe that numerous modifications and alterations of the device may be made while retaining the teachings of the invention. Accordingly, the above disclosure should be construed as limited only by the metes and bounds of the appended claims.

1. A display system embedded in an on-screen display (OSD) of a video player comprising:
an access module for providing a medium signal, the medium signal including a video signal and a subtitle signal, wherein the video signal represents a video frame on a display;
an OSD module that can receive an input data to generate a corresponding information video signal, the information video signal representing an information frame on the display, the input data being generated by a status signal received from a control module, the control module controlling the operation of the player and generating a corresponding status signal based on the operation of the player;
a coding module for mixing and coding the video signal and the information video signal into a display signal, the display signal representing a full frame on the display as the video frame overlapping the information frame; and
a parsing module for generating a text signal according to the subtitle signal and transmitting the text signal to the OSD module to make the text signal an input signal of the OSD module.

2. The display system of claim 1 wherein the display signal includes at least a visible data and at least an invisible data, the visible data being displayed on the display for viewers, the invisible data not being displayed on the display, and the coding module mixes and codes the video signal and the information signal into the visible data so that the display signal represents the full frame on the display as the video frame overlaps the information frame.

3. The display system of claim 2 wherein the subtitle signal includes a control signal and a caption signal, the control signal controlling the text signal to be coded in the format of invisible data, and the parsing module parses the caption signal within the subtitle signal to generate a corresponding text signal.

4. The display system of claim 1 embedded into an optical player, and the access module provides the medium signal based on the data of an optical disk.
